(19) United States
(12) Patent Application Publication
(10) Pub. No.: US 2012/0177900 A1
(43) Pub. Date: Jul. 12, 2012

(54) SUBSTRATE PROVIDED WITH A MULTILAYER HAVING THERMAL PROPERTIES, IN PARTICULAR FOR PRODUCING A HEATED GLAZING UNIT

(75) Inventors: Stephane Laurent, Clichy (FR); Robert Drese, Aachen (DE); Ulrich Billert, La Celle Saint-Cloud (FR)

(73) Assignee: SAINT-GOBAIN GLASS FRANCE, Courbevoie (FR)

(21) Appl. No.: 13/391,466

(22) PCT Filed: Aug. 18, 2010
(86) PCT No.: PCT/FR2010/051732

§ 371 Date: Mar. 23, 2012

(30) Foreign Application Priority Data
Aug. 21, 2009 (FR) 0955744

(51) Int. Cl. B32B 7/02

(52) U.S. Cl. 428/213

(57) ABSTRACT

The invention relates to a substrate (10), especially a transparent glass substrate, provided with a thin-film multilayer comprising an alternation of “n” metallic functional layers (40, 80, 120) especially of functional layers based on silver or a metal alloy containing silver, and of “(n+1)” antireflection coatings (20, 60, 100, 140), with n being an integer ≧3, each antireflection coating comprising at least one antireflection layer (24, 64, 104, 144), so that each functional layer (40, 80, 120) is positioned between two antireflection coatings (20, 60, 100, 140), characterized in that the thickness eₓ of each functional layer (80, 120) is less than the thickness of the preceding functional layer in the direction of the substrate (10) and is such that: eₓ=α eₓ₋₁, with:
x which is the row of the functional layer starting from the substrate (10),
x−1 which is the row of the preceding functional layer in the direction of the substrate (10),
α which is a number such that 0.5≦α<1, and preferably 0.5≦α≦0.95, or even 0.6≦α≦0.95, and
the thickness of the first metallic functional layer starting from the substrate is such that: 10≦e₁≦18 in nm, and preferably 11≦e₁≦15 in nm.

The invention relates to a transparent substrate, especially made of a rigid mineral material such as glass, said substrate being coated with a thin-film multilayer comprising several functional layers that can act on solar radiation and/or infrared radiation of long wavelength.

The invention relates more particularly to a substrate, especially a transparent glass substrate, provided with a thin-film multilayer comprising an alternation of “n” metallic functional layers, especially of functional layers based on silver or on a metal alloy containing silver, and of “(n+1)” antireflection coatings, with n being an integer ≧3, so that each functional layer is positioned between two antireflection coatings. Each coating comprises at least one antireflection layer and each coating being, preferably, composed of a plurality of layers, at least one layer, or even each layer, of which is an antireflection layer.

The invention relates more particularly to the use of such substrates for manufacturing thermal insulation and/or solar protection glazing units. These glazing units may equally be intended for equipping both buildings and vehicles, especially with a view to reducing air-conditioning load and/or preventing excessive overheating (called “solar control” glazing) and/or reducing the amount of energy dissipated to the outside (called “low-E” or “low-emissivity” glazing) brought about by the ever increasing use of glazed surfaces in buildings and vehicle passenger compartments.

These substrates may in particular be integrated into electronic devices and the multilayer may then act as an electrode for the conduction of a current (lighting device, display device, voltaic panel, electrochromic glazing, etc.) or may be integrated into glazing units having particular functionalities, such as for example heated glazing units, and in particular heated vehicle windshields.

Within the sense of the present invention, a multilayer having several functional layers is understood to mean a multilayer comprising at least three functional layers.

Multilayers having several functional layers are known.

In this type of multilayer, each functional layer is positioned between two antireflection coatings each comprising, in general, several antireflection layers which are each made of a material of nitride type and especially silicon nitride or aluminum nitride and/or of oxide type. From an optical point of view, the purpose of these coatings which flank the functional layer is to “antireflect” this functional layer.

A very thin blocker coating is however interposed sometimes between one or each antireflection coating and an adjacent functional layer: a blocker coating positioned beneath the functional layer in the direction of the substrate and a blocker coating positioned on the functional layer on the opposite side from the substrate and which protects this layer from any degradation during the deposition of the upper antireflection coating and during an optional high-temperature heat treatment of the bending and/or tempering type.

Multilayers having several functional layers are known from the prior art, for example from international Patent Application No. WO 2005/051858.

In the multilayers having three or four functional layers presented in that document, the thicknesses of all the functional layers are substantially identical, that is to say that the thickness of the first functional layer, closest to the substrate, is substantially identical to the thickness of the second functional layer which is substantially identical to the thickness of the third functional layer, or even which is substantially identical to the thickness of the fourth functional layer when there is a fourth functional layer. See, for example, examples 11 and 12 from that document.

That document furthermore presents an example, example 14, in which the thickness of the first functional layer, the closest to the substrate, is less than the thickness of the second functional layer which is itself less than the thickness of the third functional layer, according to the teaching of European Patent Application No. EP 645 352.

This European Patent Application No. EP 645 352 teaches that a multilayer having three metallic functional layers which are positioned with their thickness increasing starting from the substrate makes it possible to obtain a color in external reflection (that is to say on a side of the substrate opposite that which bears the thin-film multilayer) which is neutral.

However, it appears that the configuration from example 14 of Application No. WO 2005/051858 is not entirely satisfactory for a laminated glazing unit.

It appears that positioning three metallic functional layers with their thickness increasing starting from the substrate actually makes it possible to obtain a more neutral color in external reflection, but it appears, furthermore, that the surface resistance of the multilayer, both for example 14 and for examples 11 and 12, having an identical total thickness of silver, could be improved and that consequently the associated properties could be improved (increased energy reflection, in particular at constant light transmission, increased sheet resistance of the multilayer).

The objective of the invention is thus to provide a multilayer which has a very low sheet resistance in order, in particular, for the glazing unit integrating this multilayer to be able to exhibit a high energy reflection and/or a very low emissivity and/or to be able to be heated by applying a current between two busbars electrically connected to the multilayer, and also a high light transmission and a relatively neutral color, in particular in laminated configuration, and for these properties preferably to be obtained after one (or more) high-temperature heat treatment(s) of the bending and/or tempering and/or annealing type, or even for these properties to be maintained within a restricted range whether or not the multilayer undergoes one (or more) of such heat treatment(s).

One subject of the invention is thus, in its broadest sense, a substrate, especially a transparent glass substrate, according to claim 1. This substrate is provided with a thin-film multilayer comprising an alternation of “n” metallic functional layers, especially of functional layers based on silver or a metal alloy containing silver, and of “(n+1)” antireflection coatings, with n being an integer ≧3, each antireflection coating comprising at least one antireflection layer, so that each functional layer is positioned between two antireflection coatings. The thickness eₓ of each functional layer of the multilayer (that is to say at least of the functional layers of row 2 and of row 3 starting from the substrate) is thus less than the thickness of the preceding functional layer in the direction of the substrate and is such that: eₓ=α eₓ₋₁, with x which is the row of the functional layer starting from the substrate, x−1 which is the row of the preceding functional layer in the direction of the substrate and α which is a number such that 0.5≦α<1, and preferably 0.55≦α≦0.95, or even 0.6≦α≦0.95.

The term “row” within the meaning of the present invention is understood to mean the numbering, in integers, of each functional layer starting from the substrate: the functional layer closest to the substrate being the functional layer of row 1, the next moving away from the substrate being that of row 2, etc.

The thickness of the first metallic functional layer starting from the substrate (that of row 1) is such that: 10≦e₁≦18 in nm and preferably 11≦e₁≦15 in nm.

Thus, when 0.55≦α≦0.95, the thickness of the first metallic functional layer starting from the substrate is such that: 10≦e₁≦18 in nm and preferably 11≦e₁≦15 in nm and when 0.6≦α≦0.95, the thickness of the first metallic functional layer starting from the substrate is such that: 10≦e₁≦18 in nm and preferably 11≦e₁≦15 in nm.

It is furthermore possible that 0.6≦α≦0.9 and that the thickness of the first metallic functional layer starting from the substrate is such that: 10≦e₁≦18 in nm and preferably 11≦e₁≦15 in nm, or even that 0.6≦α≦0.85 and that the thickness of the first metallic functional layer starting from the substrate is such that: 10≦e₁≦18 in nm and preferably 11≦e₁≦15 in nm.

Furthermore, due to the fact that an essential objective of the invention is to arrive at a multilayer having a low sheet resistance, the total thickness of the metallic functional layers is, especially when 11≦e₁≦15 in nm, preferably greater than 30 nm and it is especially between 30 and 60 nm including these values, or even this total thickness is between 35 and 50 nm for a thin-film multilayer having three functional layers, or even this total thickness is between 40 and 60 nm for a thin-film multilayer having four functional layers.

Preferably, the value of a is different (by at least 0.02) for all the functional layers of row 2 and higher of the multilayer to which the above formula is applied.

It is important to observe here that the decrease in the distribution of the thicknesses which is the subject of the invention, is not a decrease in the distribution of all the layers of the multilayer (taking into account the antireflection layers), but only a decrease in the distribution of the thicknesses of the functional layers.

Within the multilayer according to the invention having decreasing functional layer thickness starting from the substrate, all the functional layers have different thicknesses; however, the distribution in the thickness of the functional layers within the multilayer makes it possible, completely surprisingly, to obtain a better sheet resistance than in the configuration having constant functional layer thickness or having increasing functional layer thickness starting from the substrate.

Unless otherwise indicated, the thicknesses mentioned in the present document are physical, or actual, thicknesses (and not optical thicknesses).

Furthermore, when a vertical position of a layer is cited (e.g.: underneath/on top), it is always by considering that the carrier substrate is positioned horizontally, on the bottom, with the multilayer on top of it; when it is specified that a layer is deposited directly onto another, this means that there cannot be one (or more) layer(s) interposed between these two layers. The row of the functional layers is here always defined starting from the substrate carrying the multilayer (substrate on the face of which the multilayer is deposited).

The antireflection layer which is at the very least included in each antireflection coating, as defined above, has an optical index measured, as is customary, at 550 nm that is between 1.8 and 2.5 including these values, or, preferably, between 1.9 and 2.3 including these values, that is to say an optical index that may be considered to be high.

In one particular variant, the last layer of the first antireflection coating subjacent to the first functional layer starting from the substrate is a wetting layer based on crystalline (i.e. non-amorphous) oxide, especially based on zinc oxide, optionally doped with the aid of at least one other element, such as aluminum and this first antireflection coating subjacent to the first functional layer comprises a smoothing layer, made of a non-crystalline mixed oxide, said smoothing layer being in contact with said superjacent wetting layer.

In this particular variant, the thickness of said smoothing layer preferably represents around ⅙ of the thickness of said first antireflection coating and around half the thickness of said first functional layer.

In another particular variant, said antireflection coatings each comprise at least one layer based on silicon nitride, optionally doped with the aid of at least one other element, such an aluminum, and preferably each antireflection coating each comprises at least one layer based on silicon nitride, optionally doped with the aid of at least one other element, such as aluminum.

In this other particular variant, the last layer of each antireflection coating subjacent to a functional layer is a wetting layer based on crystalline oxide, especially based on zinc oxide, optionally doped with the aid of at least one other element, such as aluminum.

However, in this other particular variant, at least one antireflection coating subjacent to a functional layer, and preferably each antireflection coating subjacent to a functional layer, comprises at least one smoothing layer, made of a non-crystalline mixed oxide, said smoothing layer being in contact with a superjacent wetting layer.

The thickness of each functional layer is preferably between 8 and 20 nm, including these values, or even between 10 and 18 in nm including these values, and more preferably between 11 and 15 in nm including these values.

The multilayer according to the invention is a multilayer with low sheet resistance such that its sheet resistance R in ohms per square is, preferably, less than or equal to 1 ohm per square after an optional heat treatment of the bending, tempering or annealing type, or even less than or equal to 1 ohm before heat treatment since such treatment generally has the effect of reducing the sheet resistance.

The present invention furthermore relates to the glazing unit incorporating at least one substrate according to the invention, optionally combined with at least one other substrate and especially a multiple glazing unit of the double-glazing or triple-glazing or laminated-glazing type and in particular laminated glazing comprising means for the electrical connection of the thin-film multilayer in order to make it possible to produce a heated laminated glazing unit, said substrate bearing the multilayer possibly being bent and/or tempered.

Each substrate of the glazing unit may be clear or tinted. At least one of the substrates may especially be made of bulk-tinted glass. The choice of coloration type will depend on the level of light transmission and/or on the colorimetric appearance that is/are desired for the glazing once its manufacture has been completed.

The glazing unit according to the invention may have a laminated structure, especially combining at least two rigid substrates of the glass type with at least one sheet of thermoplastic polymer, in order to have a structure of the glass/thin-film multilayer/sheet(s)/glass type. The polymer may especially be based on polyvinyl butyral (PVB), ethylene/vinyl acetate (EVA), polyethylene terephthalate (PET) or polyvinyl chloride (PVC).

The glazing unit may then have a structure of the type: glass/thin-film multilayer/polymer sheet(s)/glass.

The glazing units according to the invention are capable of undergoing a heat treatment without damaging the thin-film multilayer. They are therefore possibly bent and/or tempered.

The glazing may be bent and/or tempered when consisting of a single substrate, that provided with the multilayer. Such glazing is then referred to as “monolithic” glazing. If the glazing is bent, especially for the purpose of forming glazing units for vehicles, the thin-film multilayer is preferably on a face which is at least partly nonplanar.

The glazing may also be a multiple glazing unit, especially a double-glazing unit, at least the substrate bearing the multilayer being able to be bent and/or tempered. It is preferable in a multiple glazing configuration for the multilayer to be placed so as to face the intermediate gas-filled space. In a laminated structure, the substrate bearing the multilayer may be in contact with the polymer sheet.

The glazing may also be a triple-glazing unit composed of three sheets of glass separated in pairs by a gas-filled space. In a triple-glazing structure, the substrate bearing the multilayer may be on face 2 and/or on face 5, when considering that the incident direction of the sunlight passes through the faces in the order of increasing face number.

When the glazing is monolithic glazing or multiple glazing of the double-glazing, triple-glazing or laminated-glazing type, at least the substrate bearing the multilayer may be made of bent or tempered glass, it being possible for this substrate to be bent or tempered before or after deposition of the multilayer.

The invention also relates to the use of the substrate according to the invention for producing a glazing unit having high energy reflection and/or a glazing unit having very low emissivity and/or a heated glazing unit with a transparent coating heated by the Joule effect.

The invention also relates to the use of the substrate according to the invention for producing a transparent electrode of an electrochromic glazing unit or of a lighting device or of a display device or of a photovoltaic panel.

The substrate according to the invention may, in particular, be used for producing a substrate having high energy reflection and/or a substrate having very low emissivity and/or a heated transparent coating of a heated glazing unit.

The substrate according to the invention may, in particular, be used for producing a transparent electrode of an electrochromic glazing unit (this glazing unit being monolithic glazing or multiple glazing of the double-glazing or triple-glazing or laminated-glazing type) or of a lighting device or of a display screen or of a photovoltaic panel. (The term “transparent” should be understood here in these preceding paragraphs as meaning “non-opaque”).

The multilayer according to the invention makes it possible, at identical total functional layer thickness, to obtain a lower sheet resistance than when the thicknesses of the functional layers are all approximately identical in the multilayer or than when the thicknesses of the functional layers are positioned in an order of increasing thicknesses starting from the substrate.

Indeed, it has come to light that the contribution of each functional layer in the complete resistance of the multilayer is not uniform; surprisingly, it has been discovered that the first functional layer contributes almost half to the complete resistance of the multilayer. The thicker the first functional layer is, the lower the sheet resistance of the multilayer will be in comparison with multilayers that have the same total functional layer thickness. This is the reason why α<1, and preferably α≦0.95.

To bring about, as indicated by the invention, a decreasing distribution of the thicknesses of the functional layers starting from the substrate makes it possible to obtain a very low sheet resistance of the multilayer, while obtaining a variation of color in reflection as a function of the angle that is certainly worse than with an increasing distribution of the thicknesses but all the same obtaining a variation of color in reflection as a function of the angle which is acceptable.

However, it is important that the difference in thickness from one functional layer to the next in the direction of the substrate or on the opposite side from the substrate is not too great. This is the reason why α≧0.5, and preferably α≧0.55, or even α≧0.6.

The details and advantageous features of the invention will emerge from the following non-limiting examples, illustrated by means of the appended figures that illustrate:

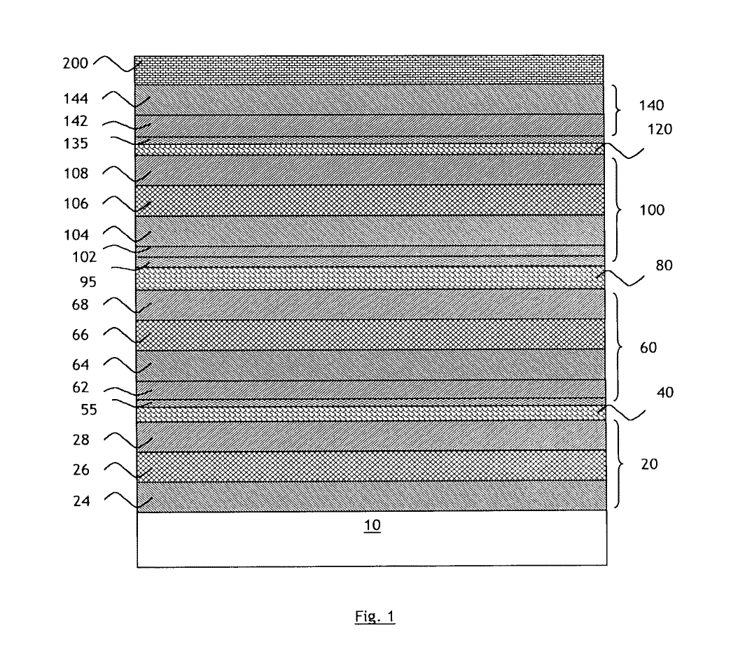

in FIG. 1, a multilayer having three functional layers according to the invention, each functional layer not being provided with an underblocker coating but being provided with an overblocker coating and the multilayer also being provided with an optional protective coating; and

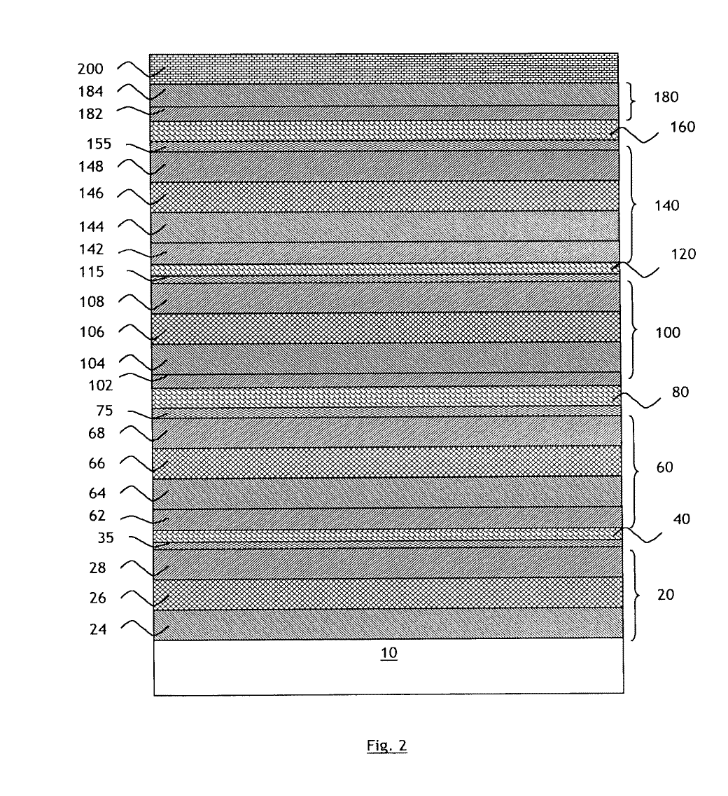

in FIG. 2, a multilayer having four functional layers according to the invention, each functional layer being provided with an underblocker coating but not with an overblocker coating and the multilayer also being provided with an optional protective coating.

In FIGS. 1 and 2, the proportions between the thicknesses of the various layers are not rigorously respected in order to facilitate the reading thereof.

FIG. 1 illustrates a multilayer structure having three functional layers 40, 80, 120, this structure being deposited on a transparent glass substrate 10.

Each functional layer 40, 80, 120 is positioned between two antireflection coatings 20, 60, 100, 140, so that the first functional layer 40 starting from the substrate is positioned between the antireflection coatings 20, 60; the second functional layer 80 is positioned between the antireflection coatings 60, 100 and the third functional layer 120 is positioned between the antireflection coatings 100, 140.

These antireflection coatings 20, 60, 100, 140 each comprise at least one dielectric layer 24, 26, 28; 62, 64, 66, 68; 102, 104, 106, 108; 142, 144.

Optionally, on one side each functional layer 40, 80, 120 may be deposited on an underblocker coating (not illustrated) positioned between the subjacent antireflection coating and the functional layer and on the other side each functional layer may be deposited directly beneath an overblocker coating 55, 95, 135 positioned between the functional layer and the antireflection coating superjacent to this layer.

A first example is carried out by following example 14 from International Patent Application No. WO 2005/051858 and by using, furthermore, the teaching of International Patent Application No. WO 2007/101964, with a smoothing layer 26 made of a mixed tin zinc oxide inserted into the first antireflection coating 20 starting from the substrate 10, the coating subjacent to the first metallic functional layer, between, on one side, a barrier layer (reference 24) made of silicon nitride which is here found to be deposited directly on the substrate 10 and a wetting layer 28 made of zinc oxide.

Three examples were carried out, numbered 1 to 3 below. All three were incorporated into a laminated glazing unit of the following structure: glass substrate bearing the multilayer/PVB interlayer sheet/glass substrate.

Table 1 below summarizes the materials and the thicknesses of each layer and of each component of the laminated structure as a function of its position with respect to the substrate bearing the multilayer (last line of the table); the numbers in the 2^{nd} column correspond to the references from FIG. 1.

TABLE 1

| | No. | Ex. 1 | Ex. 2 | Ex. 3 |
|---|---|---|---|---|
| Substrate | | 2.1 mm | 2.1 mm | 2.1 mm |
| Interlayer | | 0.76 mm | 0.76 mm | 0.76 mm |
| Si₃N₄ | 144 | 28 | 28 | 32 |
| ZnO | 142 | 7 | 7 | 7 |
| NiCr | 135 | 0.5 | 0.5 | 0.5 |
| Ag₃ | 120 | 11 | 15 | 13 |
| ZnO | 108 | 7 | 7 | 7 |
| SnZnO | 106 | 7 | 7 | 7 |
| Si₃N₄ | 104 | 50 | 59 | 52 |
| ZnO | 102 | 7 | 7 | 7 |
| NiCr | 95 | 0.5 | 0.5 | 0.5 |
| Ag₂ | 80 | 13 | 13 | 13 |
| ZnO | 68 | 7 | 7 | 7 |
| Si₃N₄ | 64 | 59 | 50 | 66 |
| ZnO | 62 | 7 | 7 | 7 |
| NiCr | 55 | 0.5 | 0.5 | 0.5 |
| Ag₁ | 40 | 15 | 11 | 13 |
| ZnO | 28 | 7 | 7 | 7 |
| SnZnO | 26 | 7 | 7 | 7 |
| Si₃N₄ | 24 | 28 | 28 | 42 |
| Substrate | 10 | 1.6 mm | 1.6 mm | 1.6 mm |

In all the examples below, the thin-film multilayer is deposited on a substrate made of clear soda-lime glass having a thickness of 1.6 mm, marketed by SAINT-GOBAIN.

Each antireflection coating 20, 60, 100 subjacent to a functional layer 40, 80, 120 comprises a last wetting layer 28, 68, 108 based on aluminum-doped crystalline zinc oxide and which is in contact with the functional layer 40, 80, 120 deposited just above.

As can be seen in table 1, the first antireflection coating 20 subjacent to the first functional layer 40 and the 3^{rd} antireflection coating 100 subjacent to the 3^{rd} functional layer 120 comprises a smoothing layer 26, 106 made of a non-crystalline mixed oxide, each smoothing layer 26, 106 being in contact with each superjacent wetting layer 28, 108.

The thickness e₂₆ of the smoothing layer 26 represents around ⅙ of the thickness of said first antireflection coating 20 and around half of the thickness of said first functional layer 40.

The thickness e₁₀₆ of the smoothing layer 106 is identical to the thickness e₂₆ of the smoothing layer 26.

The other antireflection coating 60, subjacent to a functional layer 80, could also comprise at least one smoothing layer 66, made of a non-crystalline mixed oxide, in contact with a superjacent wetting layer 68, as in FIG. 1; but this is not the case for examples 1 to 3 for reasons of availability of space for the cathode in the deposition chamber used.

Each antireflection coating 20, 60, 100, 140 comprises a layer 24, 64, 104, 144 based on aluminum-doped silicon nitride. These layers are important for obtaining the barrier effect to oxygen during the heat treatment.

In FIG. 1, it is observed that the multilayer finishes with an optional protective layer 200, which is not present for examples 1 to 3.

For each of the three examples, the deposition conditions for the layers, which were deposited by sputtering (sputtering refers to “magnetron sputtering”), are the following:

TABLE 2

| | | Deposition | |
|---|---|---|---|
| Layer | Target used | pressure | Gas |
| Si₃N₄ | Si:Al at 92:8 wt % | 1.5 × 10⁻³ mbar | Ar/(Ar + N2) at |
| | | | 45% |
| SnZnO | SnZn:Sb at 34:65:1 | 2 × 10⁻³ mbar | Ar/(Ar + O2) at |
| | wt | | 58% |
| ZnO | Zn:Al at 98:2 wt % | 2 × 10⁻³ mbar | Ar/(Ar + O2) at |
| | | | 52% |
| NiCr | NiCr at 80:20 wt | 2 × 10⁻³ mbar | Ar at 100% |
| Ag | Ag | 2 × 10⁻³ mbar | Ar at 100% |

Example 1 is an example according to the invention since the distribution of the thickness of the functional layers is decreasing starting from the carrier substrate: e₁>e₂>e₃, with e₂=α e₁ and e₃=α′ e₂.

α=0.87 and α′=0.85; here they are substantially different to within 0.02.

Example 2 is not an example according to the invention since the distribution of the thickness of the functional layers is increasing starting from the carrier substrate: e₁<e₂<e₃, with e₂=β e₁ and e₃=β′ e₂.

β=1.18 and β′=1.15; they are not identical.

Example 3 is not an example according to the invention either since the distribution of the thickness of the functional layers is constant in the multilayer: e₁=e₂=e₃.

These three multilayers have, in addition, the advantage of being able to be tempered.

The sum of the thicknesses of all the functional layers of example 1 is identical to the sum of the thicknesses of all the functional layers of example 2 and of example 3: e₁+e₂+e₃ from example 1=e₁+e₂+e₃ from example 2 or from example 3=39 nm.

Since these three examples have the same total functional layer thickness, they should have, normally, the same sheet resistances and consequently the same energy reflection and energy transmission characteristics.

However, this is not what was observed. Table 3 summarizes, for examples 1 to 3, the sheet resistance measured for each substrate bearing the multilayer after heat treatment (bending at 640°) and the main optical characteristics measured for the complete laminated glazing unit integrating the substrate bearing the multilayer:

TABLE 3

| | R | | | | | | |
|---|---|---|---|---|---|---|---|
| | (Ohm/square) | T_{L} (%) | R_{L} (%) | a_{R0}* | b_{R0}* | a_{R60}* | b_{R60}* |
| Ex. 1 | 0.98 | 73.3 | 12.4 | −4.1 | −5.1 | −5.5 | −0.2 |
| Ex. 2 | 1.05 | 67.8 | 12.5 | −5.8 | −5.7 | −3.7 | −1.7 |
| Ex. 3 | 1 | 69.3 | 16.7 | −4.9 | −5.6 | −7.2 | +0.2 |

For these substrates,
R indicates: the sheet resistance of the multilayer, in ohms per square after heat treatment (bending);
T_{L} indicates: the light transmission in the visible range in %, measured under the illuminant A at 10° Observer;
a_{R0}* and b_{R0}* indicate the colors in reflection a* and b* in the LAB system measured under the illuminant D65 at 10° Observer and thus measured substantially perpendicular to the glazing unit;
a_{R60}* and b_{R60}* indicate the colors in reflection a* and b* in the LAB system measured under the illuminant D65 at 10° Observer and measured substantially with an angle of 60° relative to the perpendicular to the glazing unit.

It is thus observed that although example 3 is satisfactory in terms of sheet resistance of the multilayer and of light transmission, its light reflection is relatively high and it does not exhibit color stability in reflection and at an angle: the difference between the color values measured at 0° and the color values measured at 60° is too great and the value of a_{R60}* is too high.

Example 2 has better optical characteristics than example 3 with, in particular, a less pronounced color in reflection at 60° (a_{R60}* less high), but the light transmission is degraded and above all the sheet resistance is greater than 1 Ohm/square, which is not acceptable.

Example 1 exhibits improved sheet resistance of the multilayer and improved light transmission relative to those of example 3 and definitely of example 2, a lower light reflection than that of example 3 and a better stability of the color in reflection as a function of the angle than example 3.

It was measured that the functional layer 40 of each of these examples is of better quality than the other functional layers 80, 120, etc.: it has a lower roughness and is better crystallized than the others.

Due to the large total thickness of the silver layers (and therefore the low sheet resistance obtained) and also the good optical properties (in particular the light transmission in the visible range), it is possible, moreover, to use the substrate coated with the multilayer according to the invention to produce a transparent electrode substrate.

This transparent electrode substrate may be suitable for an organic light-emitting device, in particular by replacing the silicon nitride layer 144 from example 1 with a conductive layer (having, in particular, a resistivity of less than 10⁵ Ω.cm) and especially an oxide-based layer. This layer may be, for example, made of tin oxide or based on zinc oxide optionally doped with Al or Ga, or based on a mixed oxide and especially on indium tin oxide ITO, indium zinc oxide IZO, tin zinc oxide SnZnO that is optionally doped (for example with Sb, F). This organic light-emitting device may be used for producing a lighting device or a display device (screen).

FIG. 2 illustrates a multilayer structure having four functional layers 40, 80, 120, 160, this structure being deposited on a transparent glass substrate 10.

Each functional layer 40, 80, 120, 160 is positioned between two antireflection coatings 20, 60, 100, 140, 180, so that the first functional layer 40 starting from the substrate is positioned between the antireflection coatings 20, 60; the second functional layer 80 is positioned between the antireflection coatings 60, 100; the third functional layer 120 is positioned between the antireflection coatings 100, 140; and the fourth functional layer 160 is positioned between the antireflection coatings 140, 180.

These antireflection coatings 20, 60, 100, 140, 180 each comprise at least one dielectric layer 24, 26, 28; 62, 64, 66, 68; 102, 104, 106, 108; 144, 146, 148; 182, 184.

Optionally, on one side each functional layer 40, 80, 120, 160 may be deposited on an underblocker coating 35, 75, 115, 155 positioned between the subjacent antireflection coating and the functional layer and on the other side each functional layer may be deposited directly beneath an overblocker coating (not illustrated) positioned between the functional layer and the superjacent antireflection coating.

In FIG. 2 it is observed that the multilayer terminates with an optional protective layer 200, in particular based on an oxide, especially that is sub-stoichiometric in oxygen.

Each antireflection coating 20, 60, 100, 140 subjacent to a functional layer 40, 80, 120, 160 comprises a last wetting layer 28, 68, 108, 148 based on aluminum-doped crystalline zinc oxide and which is in contact with the functional layer 40, 80, 120, 160 deposited just above.

Each antireflection coating 20, 60, 100, 140 subjacent to a functional layer 40, 80, 120, 160 may furthermore comprise a smoothing layer 26, 66, 106, 146 made of a non-crystalline mixed oxide, each smoothing layer 26, 66, 106, 146 being in contact with each superjacent wetting layer 28, 68, 108, 148.

Each antireflection coating 20, 60, 100, 140, 180 comprises a layer 24, 64, 104, 144, 184 based on aluminum-doped silicon nitride. These layers are large in order to obtain the oxygen barrier effect during the heat treatment.

Generally, the transparent electrode substrate may be suitable as a heated substrate for a heated glazing unit and in particular a heated laminated windshield.

It may also be suitable as a transparent electrode substrate for any electrochromic glazing, any display screen, or else for a photovoltaic cell and especially for a front face or a rear face of a transparent photovoltaic cell.

The present invention is described in the aforegoing by way of example. It is understood that a person skilled in the art is capable of carrying out various variants of the invention without however departing from the scope of the patent as defined by the claims.

1. A substrate, comprising, on a surface of the substrate, a thin-film multilayer comprising an alternation of:
(i) at least three metallic functional layers; and
(ii) one more antireflection coating than a total number of metallic functional layers,
wherein each antireflection coating comprises an antireflection layer, so that each metallic functional layer is positioned between two antireflection coatings, and
wherein a thickness, eₓ, of each metallic functional layer is less than a thickness of a preceding metallic functional layer in a direction of the substrate and satisfies:
eₓ=α eₓ₋₁,
wherein:
x is a row of the functional layer, numbered from the substrate surface;
x−1 is a row of the preceding metallic functional layer in the direction of the substrate;
α satisfies an equation: 0.5≦α<1; and
a thickness of first metallic functional layer, e₁, contacting the substrate surface satisfies an equation: 10≦e₁≦18 in nm.

2. The substrate of claim 1, α is different for each metallic functional layer of row 2 and higher.

3. The substrate of claim 1, wherein a last layer of a first antireflection coating subjacent to a first metallic functional layer from the surface of the substrate is a wetting layer comprising a crystalline oxide, optionally doped with another element, and
the first antireflection coating comprises a smoothing layer comprising a non-crystalline mixed oxide, which contacts the superjacent wetting layer.

4. The substrate of claim 3, wherein the thickness e₂₆ of the smoothing layer is around ⅙ of a thickness of the first antireflection coating and around half a thickness of the first metallic functional layer.

5. The substrate of claim 1, wherein a total thickness of the metallic functional layers is greater than 30 nm.

6. The substrate of claim 1, wherein the antireflection coatings each comprise a layer comprising silicon nitride, optionally doped with another element.

7. The substrate of claim 1, wherein a last layer of each antireflection coating subjacent to a metallic functional layer is a wetting layer comprising a crystalline oxide, optionally doped with another element.

8. The substrate of claim 7, wherein at least one antireflection coating subjacent to a metallic functional layer comprises a smoothing layer comprising a non-crystalline mixed oxide, which contacts a superjacent wetting layer.

9. A glazing unit, comprising:
a substrate of claim 1; and
optionally, a second substrate.

10. The substrate of claim 1, being suitable for use as a heated transparent coating of a heated glazing unit; or a transparent electrode of an electrochromic glazing unit, a lighting device, a display device, a photovoltaic, or a panel.

11. The substrate of claim 1, which is a transparent glass substrate.

12. The substrate of claim 1, wherein the metallic functional layers comprise silver or a metal alloy comprising silver.

13. The substrate of claim 1, wherein α satisfies an equation: 0.55≦α≦0.95.

14. The substrate of claim 1, wherein α satisfies an equation: 0.6≦α≦0.95.

15. The substrate of claim 1, wherein the thickness e₁ satisfies an equation: 11≦e₁≦15 in nm.

16. The substrate of claim 3, wherein the last layer of the first antireflection coating is a wetting layer comprising is a wetting layer comprising crystalline zinc oxide, optionally doped with aluminum.

17. The substrate of claim 5, wherein a total thickness of the metallic functional layers is between 30 and 60 nm, including these values.

18. The substrate of claim 5, wherein thin-film multilayer comprises three metallic functional layers and a total thickness of the metallic functional layers is between 35 and 50 nm.

19. The substrate of claim 5, wherein thin-film multilayer comprises four metallic functional layers and a total thickness of the metallic functional layers is between 40 and 60 nm.

20. The substrate of claim 7, wherein the last layer of each antireflection coating subjacent to a metallic functional layer is a wetting layer comprising crystalline zinc oxide, optionally doped with aluminum.
